(19) United States
(12) Patent Application Publication
(10) Pub. No.: US 2012/0303633 A1
(43) Pub. Date: Nov. 29, 2012

(54) SYSTEMS AND METHODS FOR QUERYING COLUMN ORIENTED DATABASES

(75) Inventors: Bin He, San Jose, CA (US); Hui-l Hsiao, Saratoga, CA (US)

(73) Assignee: INTERNATIONAL BUSINESS MACHINES CORPORATION, Armonk, NY (US)

(21) Appl. No.: 13/116,387

(22) Filed: May 26, 2011

(51) Int. Cl. G06F 17/30

(52) U.S. Cl. 707/745; 707/E17.051

(57) ABSTRACT

Systems and methods for accessing data stored in a data array, mapping the data using a bitmap index, and processing data queries by determining positions of query attributes in the bitmap index and locating values corresponding to the positions in the data array are described herein.

### BACKGROUND

Aggregation is one of the most basic and important query operators in relational databases. It is widely used in data warehousing and decision making applications, where the data to be processed is usually quite large. Aggregation methods have been extensively studied and deployed for row oriented databases, or row stores, such as IBM® DB2® and Oracle®. IBM and DB2 are registered trademarks or trademarks of International Business Machines Corporation in the United States and/or other countries. Oracle is a registered trademark of Oracle Corporation.

Recently, column oriented databases, or column stores, have been emerging as a viable alternative to the conventional row oriented database structure. In a column store, database content is stored by column instead of by row. Each database column is stored separately, with attribute values of the same column stored contiguously. Accordingly, it is possible to efficiently access a relational database column by column instead of through the more conventional row by row access methods. However, current technology performs queries, such as aggregation, on column oriented databases utilizing query methods originally developed for row oriented databases. The row oriented database query methods are not designed to take advantage of the specific characteristics of column oriented databases.

### BRIEF SUMMARY

The subject matter described herein generally relates to database aggregation. In particular, certain subject matter presented herein provides query methods for column oriented databases. For example, systems and associated methods are described that provide techniques utilizing the bitmap index and data array of column oriented databases to process aggregation queries.

In summary, one aspect provides a system comprising: at least one processor; a system memory operatively coupled to the at least one processor; at least one database module communicatively coupled to the system memory and the at least one processor, wherein the at least one database module is adapted to: communicate with at least one database; receive at least one database query; at least one data array configured to store data in the database; and at least one bitmap index configured to map the data; wherein the at least one database query is processed by determining positions of query attributes in the at least one bitmap index and locating values corresponding to the positions in the at least one data array.

Another aspect provides a method comprising: accessing at least one database storing data in at least one data array; configuring a bitmap index to map the data; receiving at least one database query; and processing the at least one database query by determining positions of query attributes in the at least one bitmap index and locating values corresponding to the positions in the at least one data array.

A further aspect provides a computer program product comprising: a computer readable storage medium having computer readable program code embodied therewith, the computer readable program code comprising: computer readable program code configured to access at least one database storing data in at least one data array; computer readable program code configured to map the data utilizing a bitmap index; computer readable program code configured to receive at least one database query; and computer readable program code configured to process the at least one database query by determining positions of query attributes in the at least one bitmap index and locating values corresponding to the positions in the at least one data array.

The foregoing is a summary and thus may contain simplifications, generalizations, and omissions of detail; consequently, those skilled in the art will appreciate that the summary is illustrative only and is not intended to be in any way limiting. For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example bitmap index.

FIG. 2 provides an example Word-Aligned Hybrid WAH compression.

FIG. 3 illustrates an example of an aggregation process.

FIG. 4 illustration another example of an aggregation process.

FIG. 5 provides a flow diagram of an example aggregation process.

FIG. 6 provides a graph demonstrating the performance of globalHash and localHash for varying numbers of tuples.

FIG. 7 provides a graph demonstrating the performance of globalHash and localHash for varying numbers of aggregation attributes.

FIG. 8 provides a graph of bitmap-based and hash-based aggregation performance for different numbers of distinct values.

FIG. 9 provides a graph of bitmap-based and hash-based aggregation performance for different sizes of available memory.

FIG. 10 provides a graph of bitmap-based and hash-based aggregation performance for varying numbers of tuples.

FIG. 11 provides a graph of bitmap-based and hash-based aggregation performance for varying numbers of aggregation attributes.

FIG. 12 provides a graph of bitmap-based and hash-based aggregation performance for varying memory sizes using a realistic data set.

FIG. 13 provides a graph of bitmap-based and hash-based aggregation performance for different numbers of tuples using a realistic data set.

FIG. 14 provides a graph of bitmap-based and hash-based aggregation performance over varying numbers of attributes using a realistic data set.

FIG. 15 illustrates an example computer system.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the claims, but is merely representative of certain example embodiments.

Reference throughout this specification to an “embodiment” or “embodiment(s)” means that a particular feature, structure, or characteristic described in connection with the embodiment is included in at least one embodiment. Thus, the appearances of “embodiment” or “embodiment(s)” in various places throughout this specification are not necessarily all referring to the same embodiment.

Furthermore, the described features, structures, or characteristics may be combined in any suitable manner in one or more embodiments. In the following description, numerous specific details are provided to give a thorough understanding of example embodiments. One skilled in the relevant art will recognize, however, that aspects can be practiced without one or more of the specific details, or with other methods, components, materials, et cetera. In other instances, well-known structures, materials, or operations are not shown or described in detail to avoid prolixity.

Analysis and knowledge discovery of operational data has been used for many purposes, including providing business insight into customer behaviors, sales trends, and promoting sales benefits. Aggregation is a primary operation supported in relational databases for ascertaining such information.

With the information explosion of recent years, the size of data being managed by databases involved in real applications is usually at the terabyte scale, but is increasingly at the petabyte scale. For example, there could be billions of sales records in a sales database, and possibly many more if legacy sales data are also included. The processing of aggregation queries over such large databases and data warehouses is computationally intensive and time-consuming. Although computer hardware has achieved significant advancement in the past decade, increased data storage has outstripped advancements in CPU speed and available memory. Accordingly, more efficient and scalable query processing methods are needed to support the explosive growth in data application needs.

Existing aggregation query processing techniques are mostly sort-based or hash-based, and are designed only for row oriented databases. The newly emerging column oriented databases have adopted these row oriented database aggregation processing techniques. However, all of these query processes are designed and optimized based on the architecture of row oriented databases, where tuples are stored consecutively on disk. With the emergence of this new column architecture, opportunities exist to process aggregation queries that are specific and more efficient for column oriented databases.

In a column oriented database, for each relation, the data of each column of the relation is stored contiguously on disk. As such, for a specific value in a column, the positions of occurrences of this value in the column may be easily computed without much I/O. In addition, since the column data is stored contiguously, operations that need random access on the data of a column may be efficiently conducted. Embodiments leverage these two characteristics of column stores to develop more efficient aggregation processing techniques for these types of databases.

Notable database management systems that store data via columns include MonetDB, C-Store, and Vertica®. Vertica is a registered trademark of Vertica Systems, Inc. These column oriented databases support relational databases and data warehouses, including the execution of SQL queries. C-Store additionally supports hybrid structures of both row oriented and column oriented storages, as well as overlapping columns to speed up query processing. Much research has been conducted regarding column oriented databases, especially comparing them to conventional row oriented databases. Examples include demonstrating that column oriented databases are in general more efficient than row oriented databases, such as when answering queries that do not access many attributes. Other research indicates that column oriented databases are well suited for handling vertically partitioned Resource Description Framework (RDF) data, achieving an order of magnitude improvement in efficiency compared with row oriented databases. Nonetheless, in reference to aggregation queries, current column stores still appear to be adopting aggregation processes, such as hash-based aggregation processes, designed and optimized for row stores.

In conventional hash-based aggregation, a hash table is used to store the aggregation values for all the groups. When the number of groups is large, the insert/update to the hash table will generally become slow. Embodiments provide for the use of several smaller hash tables instead of one large hash table for processing aggregation queries. The use of multiple smaller hash tables according to embodiments improves the performance and efficiency of aggregation queries. In addition, embodiments provide that data are partitioned by bitmap indexes and, accordingly, no hash function is required to partition data. Rather, hash functions are only used within data.

An experiment using multiple smaller hash tables serves as a non-limiting example of using multiple smaller hash tables instead of one larger hash table. The hash table implementation used in this experiment is the map class in C++ STL. For a table with 10 million tuples, a big hash table was used to record the occurrences of the groups, which took 35.22 seconds to complete. However, if 100,000 tuples were processed using a hash table each time, the process took 26.99 seconds. The time is further reduced to 15.54 seconds if 10,000 tuples are processed in each hash table, and 12.03, 9.94 and 7.87 seconds when processing 1,000 tuples, 100 tuples and 10 tuples, respectively. Accordingly, embodiments provide methods and systems for replacing a big hash table with several smaller hash tables.

In column oriented databases, the occurrences of a specific value in a column may be computed relatively easily. In addition, random accesses on column data are efficient if the data are kept in memory. Using the occurrence information of the value and a data array, all the groups involving a specific value can be computed using a hash table. In addition, since the hash table only contains entries related to the number of entries in the hash table, the hash table will be much smaller. For example, for all values aᵢ in column A, a similar process may be conducted and the aggregation result of the column and the other columns may be efficiently computed.

Another non-limiting example involves a database with table SALES storing a set of transaction records using at least the two columns PRODUCT and STATE. In this non-limiting example, the query “SELECT PRODUCT, STATE, COUNT(*) FROM SALES GROUP BY PRODUCT, STATE” is used to obtain product data. Generating the count information of a product “Humidifier” requires finding the occurrences of “Humidifier” in PRODUCT. For each occurrence of “Humidifier,” using the data array of the STATE column, the state where a particular humidifier is sold may be ascertained. The count of all groups involving “Humidifier” is maintained in a hash table. After all occurrences of “Humidifier” are examined, the aggregation result is recorded in the hash table. The hash table for keeping the groups involving “Humidifier” will be much smaller, because all the groups are related to “Humidifier.” As there may be a larger number of products, the number of groups involving “Humidifier” is small compared with the total number of different groups in the SALES table.

The occurrence information of a value needs to be stored in memory in a manner that provides fast access. As such, a compact representation is required. Embodiments provide efficient and compact position information by using bitmap index to encode the occurrence positions of a value, using an efficient scheme, such as Word-Aligned Hybrid (WAH) and Byte-aligned Bitmap Code (BBC).

The random access of data arrays may be very efficient if the memory allocated for query processing is large enough to hold the data array of the column. However, this is usually not the case in large applications, where even the data array of one single column may not fit in memory. As such, efficient access of column data is needed when only a limited size of memory is available for query processing. Embodiments provide that when the memory size is not large enough, a divide and conquer technique is used wherein the data array and the bitmap index of the columns is partitioned into one or more smaller partitions, such that the memory allocated is enough for processing aggregation on the smaller partitions. Embodiments further provide that after the aggregations on all partitions are completed, the final result may be generated by merging the results from all partitions.

In practice, the number of aggregation attributes will normally be more than two. Accordingly, embodiments generalize the aggregation process such that aggregation queries with multiple aggregation attributes may be efficiently computed. Accordingly, embodiments provide that one of the aggregation attributes with an available bitmap index may be selected and the remaining columns treated as one single column, then the method for two aggregation attributes is applied.

Embodiments provide for aggregation methods designed for column oriented databases. In addition, embodiments provide for hash-based aggregation methods. Embodiments provide for the use of bitmap indexes with hash-based aggregation. In addition, if necessary, embodiments may use partitioned hash tables. Further embodiments provide for aggregation methods that leverage the bitmap index and the data array in column oriented databases such that aggregation computations are partitioned into a set of smaller problems, which are better able to achieve increased performance, efficiency, and scalability.

Typically, aggregation is supported as the following two forms: scalar aggregates and aggregate functions. In general, scalar aggregates compute a single value from a single input relation, such as SUM, MAX, MIN, and AVERAGE. Aggregate functions compute a set of values from the input relation, producing a relation as the result. To compute the result for aggregate function, grouping is needed for processing aggregate queries. Grouping is very similar to duplicate removal in a database, and may be implemented in a very similar way. As such, they are often used interchangeably.

In row oriented databases, aggregation requires that all data be consumed before the production of output. According to existing technology, two major types of processes for aggregation exist. One is based on sorting, and the other is based on hashing. Some research has demonstrated that the performance of hash-based aggregation is generally better than sort based aggregation.

Bitmap indexes are known to be efficient, especially for read-mostly or append-only data, and are commonly used in data warehousing applications and column oriented databases. As an example, Model 204® was the first commercial product making extensive use of a bitmap index. Model 204® is a registered trademark of Computer Corporation of America. Early bitmap indexes were used to implement inverted files. In data warehouse applications, bitmap indexes were shown to perform better than tree-based schemes, such as the variants of B-tree or R-tree. Compressed bitmap indexes are widely used in column oriented databases, such as C-Store, which contributes to its performance gain over row oriented databases. Various compression schemes for bitmap index have been developed. The development of bitmap compression methods and encoding strategies have further broaden the applicability of bitmap index. For example, bitmap index may be applied to all types of attributes and is very efficient for Online Analytical Processing (OLAP) and warehouse query processing.

A bitmap for an attribute may be viewed as v□ r matrix, where v is the number of distinct values of a column (i.e., attributes) and r is the number of rows (i.e., tuples) of the database. Each value in the column corresponds to a vector of length r in the bitmap, in which the kth position is 1 if this value appears in the kth row, and 0 otherwise.

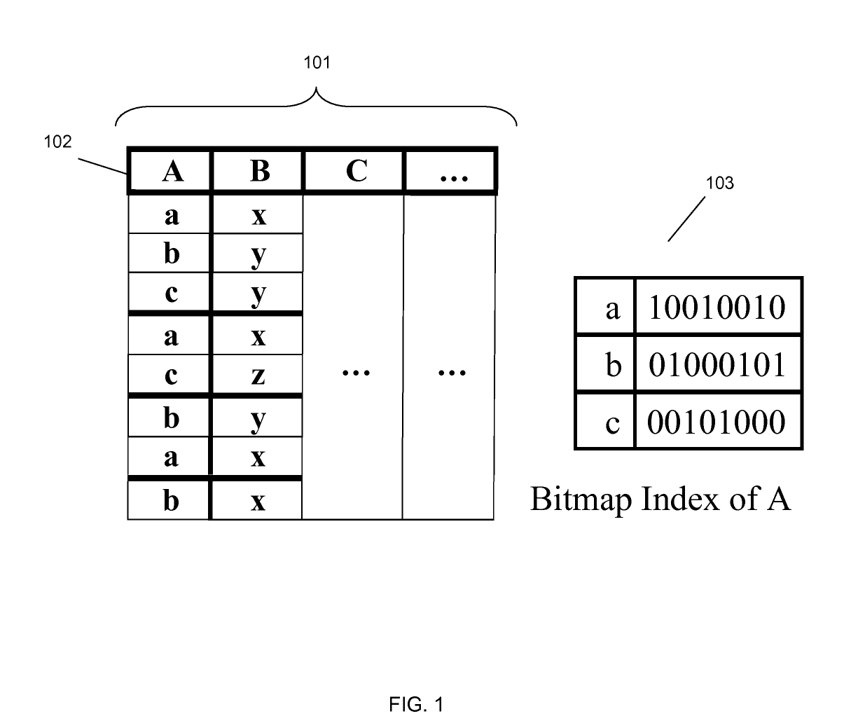

Referring to FIG. 1, therein is depicted an example bitmap index, including an example relation with a set of attributes 101, including attribute A 102, and a bitmap index of attribute A 103. As a non-limiting example, if a bitmap index is built on attribute A, there is a corresponding vector for each distinct value of A. The length of the vector is equal to the number of tuples in the table. In this example, the value of a's vector is 10010010, because a occurs in the 1st, 4th, and 7th rows in the table.

As an uncompressed bitmap is generally much larger than the original data, compression is typically used for attributes other than the primary key to reduce storage size and improve performance. In addition, with proper compression, bitmaps perform well for a column with cardinality up to 55% of the number of rows, that is, up to 55% rows having distinct values on this column.

Various compression methods for bitmaps have been proposed. For example, Word-Aligned Hybrid (WAH) and the earlier Byte-aligned Bitmap Code (BBC) are two important compression schemes that may be used for any column and for query processing without decompression. WAH can be as much as ten times faster than BBC, while occupying no more than 50% disk space. Another example is run length compression, which may be used for sorted columns. Embodiments may utilize any applicable bitmap compression scheme. Certain embodiments and non-limiting examples described herein utilize WAH compression methods.

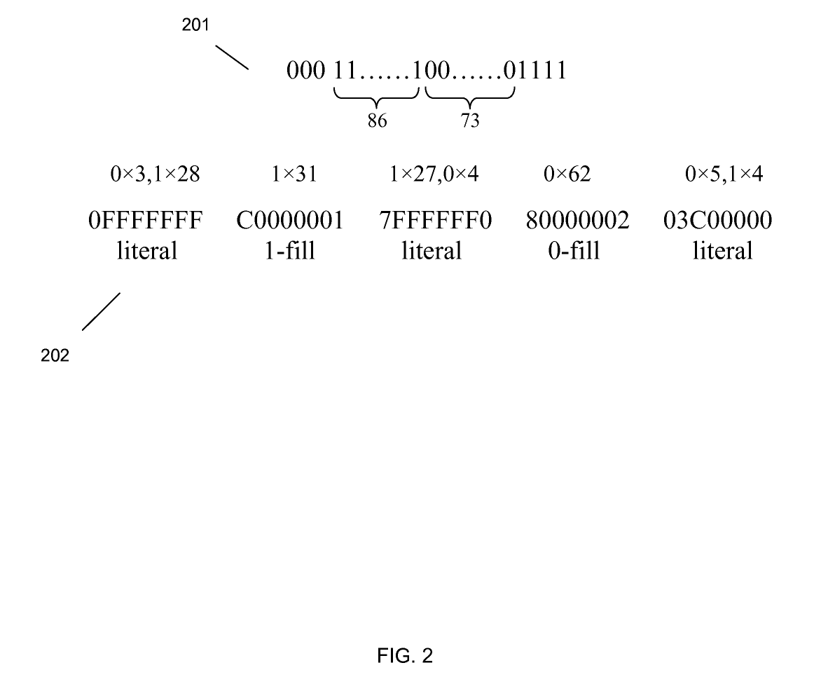

WAH organizes the bits in a vector by words. A word can be either a literal word or a fill word, distinguished by the highest bit: 0 for literal words and 1 for fill words. Using L to denote the word length in a machine, a literal word encodes L−1 bits, literally. A fill word is either a 0-fill or a 1-fill, depending on the second highest bit, 0 for 0-fill and 1 for 1-fill. Using N as the integer denoted by the remaining L−2 bits, then a fill word represents (L−1)×N consecutive 0's or 1's. FIG. 2 provides an example illustration of WAH compression, wherein a bit vector 201 is WAH-compressed into a compressed vector 202.

In column oriented databases, each column of a relation is stored continuously on disk. Each continuously stored column of data is referred to as a data array. An offset index may be built on top of the column, recording the value of the cell for each position. Given a position/offset (e.g. the row number), the value of the cell may be easily and quickly retrieved using data array.

For large hash tables, the insert/update of the hash table is costly due to collisions. In addition, performance downgrades with increased entries in the hash table. Embodiments provide that selecting a specific value of one column allows aggregation results to be split into smaller partitions. According to embodiments, if each of the partitions is computed using a hash table, the summation of the processing time of the set of smaller hash tables will be much smaller than using a large hash table. Embodiments provide for any implementation of hash tables that provide such results, including, but not limited to, STL map in C++ STL, sparse hash, and dense hash implementations. A non-limiting example of a sparse hash implementation is the implementation from the Google® Sparse Hash, project 1. Google is a trademark or registered trademark of Google, Inc. Computing aggregation using a large hash table is much more time consuming compared with computing an equivalent aggregation with a set of smaller hash tables according to embodiments. Accordingly, embodiments achieve better aggregation processing by using bitmap index and data array. In addition, embodiments process aggregation queries when memory is not big enough to hold all data to be aggregated and when there are more than two aggregation attributes.

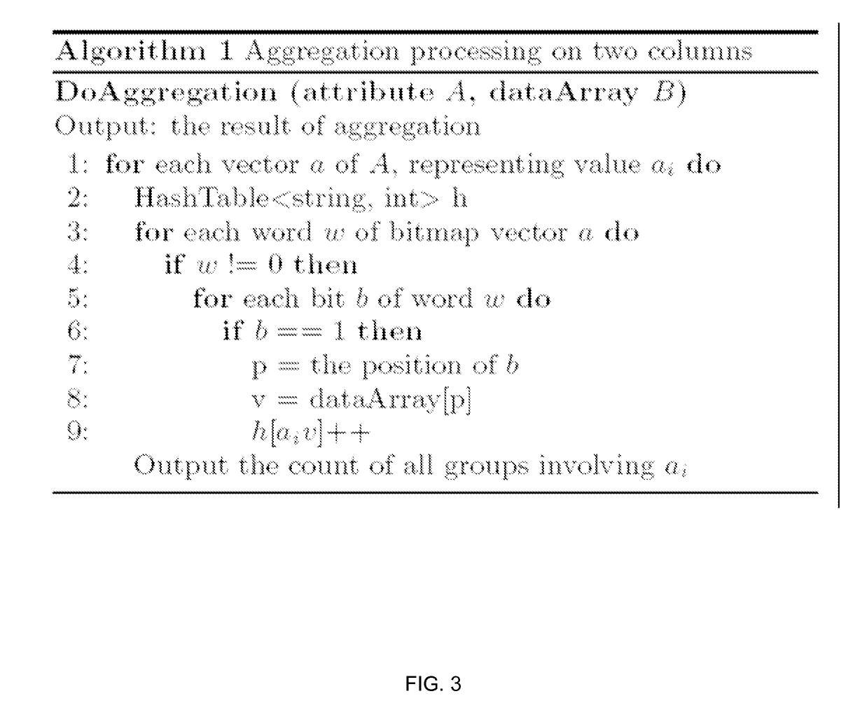

Referring to FIG. 3, therein is depicted an aggregation process on two columns according to an embodiment. In this embodiment, WAH compression was used for bitmap indexes. When computing an aggregation result involving a specific column value, one bitmap vector of a column is selected each time, as demonstrated in line 1. Aggregation processing then occurs using this bitmap vector and a data array of the other column. For each bitmap vector of a column, the 1 bits in the vector are found, as shown in lines 1-5. Using the position of the 1 bit, the value from the data array of the other column is obtained according to lines 6-7. Lines 8 and 9 provide that the count of this group is then updated using a hash table. This process continues until all bitmap vectors are processed. The computation of the position of bit b depends on the compression scheme of the bitmap.

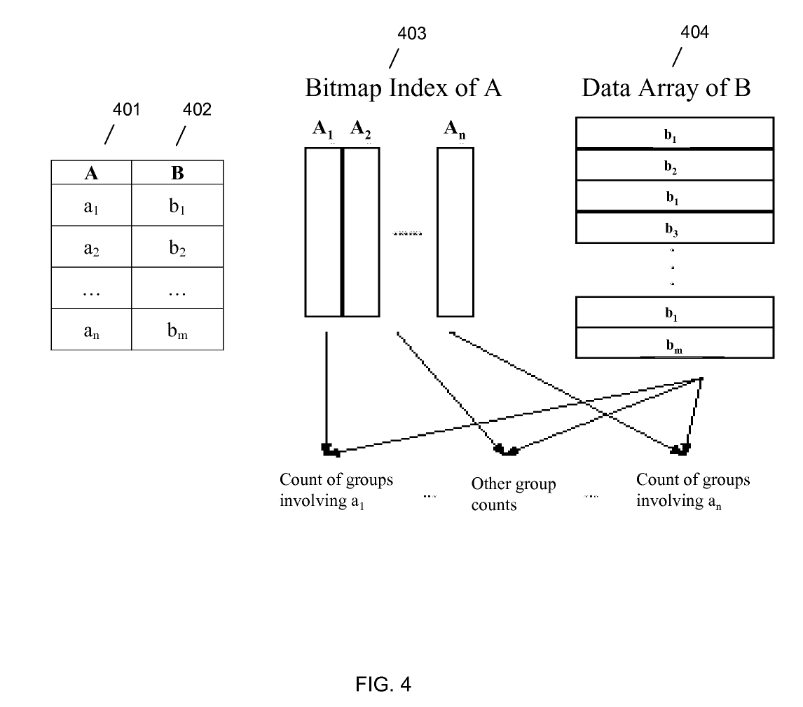

Referring to FIG. 4, therein is illustrated aggregation with two attributes according to an embodiment. The query “SELECT A, B, COUNT(*) FROM A, B GROUP BY A, B” serves as a non-limiting example, wherein a bitmap index is available on column A and the data array of column B is stored continuously on disk and can fit into memory. As shown in FIG. 4, the bitmap indexes 403 for column A 401 include n bitmap vectors A₁, A₂, . . . , Aₙ representing values a₁, a₂, . . . , aₙ in column A, respectively. FIG. 4 further illustrates a data array 404 of column B 402. Generating the count values of aggregation groups requires selecting the bitmap vector A₁ of column A 401. For each bit in A₁ where the value is 1 (e.g. the 3rd bit), the corresponding value of the same position (e.g. the 3rd position) in the data array of column B (e.g. b₁) is located. In this non-limiting example, one occurrence of a₁b₁ has been determined and the count of a₁b₁ in the hash table is updated accordingly. In addition, because column B 402 is kept in memory, random access of column B 402 data is very fast. The count values are updated until all 1 bits in A₁ are processed. All of the located groups will involve the value a₁ in this process. After processing of A₁ is complete, the counts of all groups involving a₁ are complete. The hash table may be released and the process continued for A₂ through Aₙ. For all other bitmap vectors of A, the process is repeated until, inter alia, all bitmap vectors have been processed.

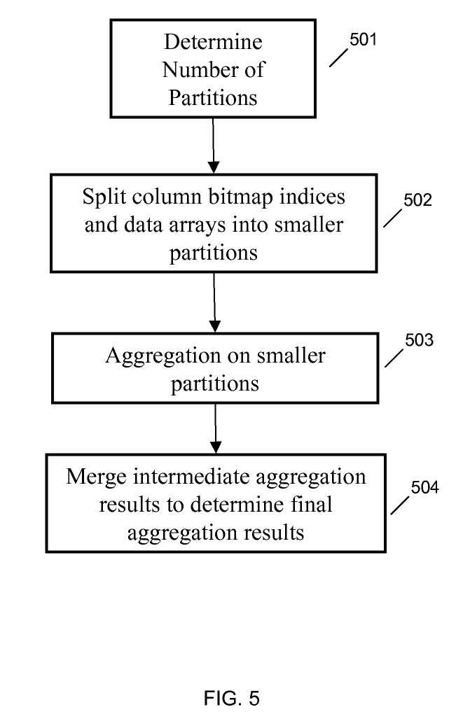

FIG. 5 provides a flow diagram of an example embodiment wherein queries are processed when there is not enough memory for all of the data. The number of partitions required by the relation is determined 501. The bitmap indexes of a column and all data arrays are split into smaller partitions 502. The aggregation is processed according to embodiments, including, but not limited to, the processes depicted in FIGS. 3 and 4, on each partition 503. The aggregation results of a partition will be in a sorted order. After aggregation on all partitions is finished, all intermediate results are merged and the final aggregation result is determined 504. As a non-limiting example, if the aggregate function is SUM, the intermediate result may contain the SUM value of a partition of data. SUM may then be applied to the intermediate values together to arrive at the final SUM value.

Another non-limiting example involves processing columns A and B, wherein the bitmap index size of A is 11 MB and the data array size of A is 20 MB. In this example, the memory size for query processing is 19 MB. Accordingly, A and B must be split into partitions. The bitmap indexes of A are split into A₁ and A₂ and the data array of B are split into B₁ and B₂. Aggregation is processed according to embodiments, including, but not limited to, the processes of FIGS. 3 and 4, with A₁ and B₁ since they can fit into memory. Aggregation is also processed for A₂ and B₂. After the processing of A₁ and B₁ and the processing of A₂ and B₂ is finished, the aggregation results are merged from these partitions and the final aggregation result produced.

Embodiments provide that minimizing the number of partitions leverages the memory given as efficiently as possible and also avoids overhead resulting from multi-way merge. In addition, embodiments provide for determining memory requirements. A non-limiting example of determining memory requirements provides for summing the size of the data array, the size of the bitmap index, and the size of memory that will be occupied by the hash map, and dividing the total memory by a given memory upper bound. Embodiments provide that the results may be rounded up and used as the number of partitions.

Embodiments provide processes for aggregation of multiple attributes. According to a first multiple aggregation embodiment, among n grouping attributes, the bitmap index of an attribute a is selected. The remaining n 1 grouping attributes are treated as one single column. Aggregation processes according to embodiments may then be applied directly. In this particular embodiment, a grouping attribute must be selected. If the attribute with the smallest bitmap index is used, the memory used by bitmap index is minimized. However, if the attribute with the largest data array size is used, the memory consumption due to data array is minimized. According to embodiments, minimizing the number of partitions does the most to decrease the cost of the final merging step. As such, certain embodiments provide for selecting the attribute that will result in the smallest number of partitions when processing the query, although other embodiments may select other attributes.

A second multiple aggregation embodiment aggregates multiple attributes by processing two grouping attributes at a time. A non-limiting example involves three grouping attributes A, B and C, wherein A and B are processed first. According to embodiments, while processing each bitmap vector, the bitmap vectors for the resulting groups may be constructed at the same time. In this non-limiting example, after A1 is processed, all the bitmap vectors for a₁b₁, a₁b₂, . . . , a₁Bₘ may be constructed. After all bitmap vectors are processed, bitmap vectors for the aggregation groups between A and B may be constructed, which will be used for further processing with C. According to embodiments, a partial bitmap vector for each group is maintained and used when generating the bitmap vector for each group during aggregation processing. The position of the last 1 bit for this group is tracked. Whenever the next 1 bit corresponding to this group is determined, the bitmap vector is updated according to the compression scheme of bitmap index. After all 1 bits in a bitmap vector are processed, new bitmap vectors for all of the groups are generated.

The first multiple aggregation embodiment results in more partitions, which results in a higher cost in the merge phase. However, the second multiple aggregation embodiment produces more intermediate results because the intermediate bitmaps need to be stored in memory (writing the intermediate bitmap to disk and reading it back for processing the next grouping attribute is obviously more costly since more I/O is needed). In addition, the number of required partitions is increased and more hash operations are conducted when processing two attributes at a time. Experiments indicate that the first multiple aggregation embodiment demonstrates increased performance when compared with the second multiple aggregation embodiment, especially when the number of grouping attributes is high. Accordingly, the construction of intermediate bitmaps and the use of more hash operations appears to be more costly compared with the costs saved when using fewer partitions.

Another non-limiting example involves a hash-based implementation that reads tuples from a file, and uses one in a memory hash table to record the count of each aggregation group seen. If a memory size bound is given, whenever the memory is not enough to keep all groups seen in memory, all entries and their count values will be written in sorted order (e.g., in alphabetical order of the group value) to temporary files. After all tuples are scanned, all intermediate results will be merged to generate the final result.

Experiments were conducted evaluating the performance of methods disclosed herein. A first experiment used two hash implementations on a relation to demonstrate that a set of smaller hash tables may be more efficient than a larger hash table. A second experiment was conducted to evaluate the effectiveness of certain embodiments, which included implementing state-of-the-art hash-based aggregation processing using hash table. In these experiments, all of the systems and processes were tested in terms of several factors, including data size, number of aggregation attributes, and the amount of memory allocated for query processing. The experiments indicated at least two results: (1) using a set of smaller hash tables for aggregation is faster than using a large hash table; and (2) aggregation processing according to embodiments outperforms the state-of-the-art aggregation processing method.

The experiments were conducted on a machine with Intel® Pentium® IV dual core processor of 3.6 GHz, 2.0 GB main memory and a 7200 rpm SATA hard drive, running Ubuntu® 9.10 with kernel 2.6.31-19. Intel and Pentium are registered trademarks of the Intel Corporation. Ubuntu is a trademark or registered trademark of Canonical Limited. Both the hash-based aggregation method and the bitmap-based method were implemented in the C++ programming language. However, other hardware and software components and configurations are equally applicable and embodiments are not limited to those components and configurations specified in these experiments.

In these experiments a hash-based process termed “globalHash” was used that assumed that the memory size was large enough to hold all of the aggregation groups and their counts in the hash table in memory. A second experimental hash-based process, referred to as “localHash,” used only small hash tables and did not produce final aggregation results, but rather, only provided partial results. Given a number that denoted the maximum size of tuples (e.g. 10,000) a hash table may process, localHash read tuples from the file and stored the count of each group in a hash table. Whenever the number of tuples scanned reached the maximum tuple number given, the hash table was dropped and a new hash table was used when the next tuple was scanned. Embodiments provide that by replacing a global hash function with a number of local hash functions using the bitmap index partition, a significant improvement in hashing performance, and therefore aggregation performance, may be achieved.

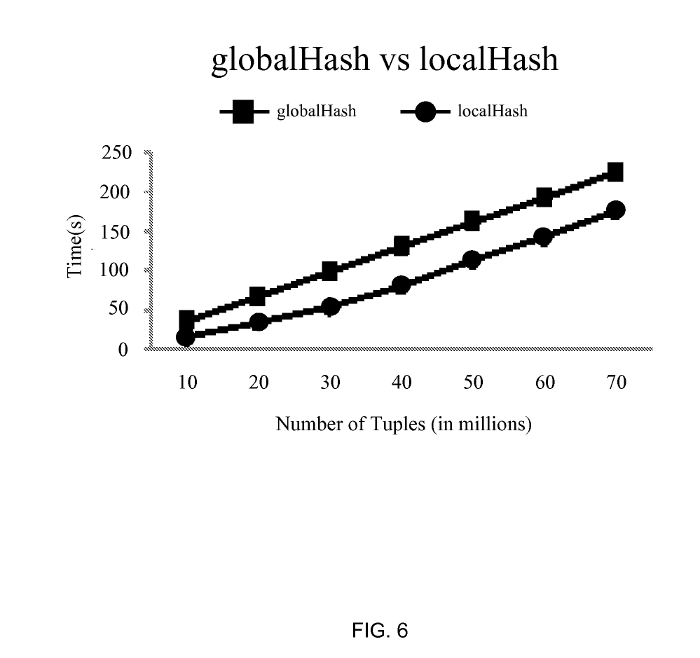

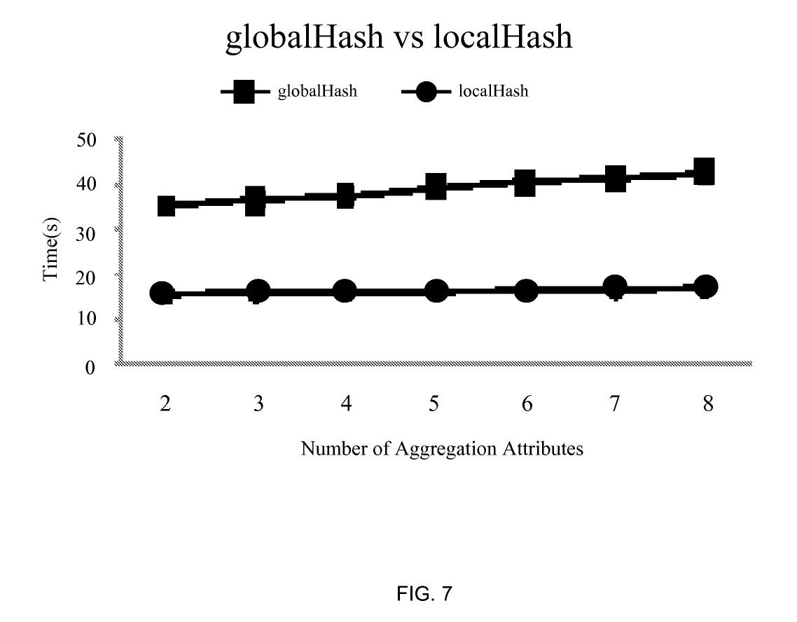

FIG. 6 illustrates the performance of globalHash and localHash for varying numbers of tuples. For a relation with 10 million tuples, the performance of globalHash and localHash over varying numbers of aggregation attributes are shown in FIG. 7. In this experiment, the maximum size of tuples a small hash can process is given as 10,000. As demonstrated in FIG. 7, the performance of localHash presents a significant performance gain compared with globalHash. In practice, collisions will usually happen when computing hash values of an entry. As the number of possible entries is increases, the possibility of collisions also increases. With a large number of collisions, the performance of the hash table will downgrade when more and more insert/update operations are conducted on the hash table. For the experimental results in FIG. 7, the number of aggregation attributes was fixed at 2 and the number of tuples were varied in the relation from 10 million to 40 million.

In most real applications, the memory available for query processing is quite limited. Accordingly, experiments were conducted comparing the performance of the hash-based method and the bitmap-based method according to embodiments in situations where a memory upper limit for query processing was specified. Experiments tested both methods with a synthetic data set, generated according to Zipfian distribution, and a realistic data set. Experimental results showed that bitmap-based aggregation methods according to embodiments are memory-efficient and outperform the hash-based aggregation method in most cases. In the experiments described herein, each data set was tested by varying different parameters, including the number of tuples in the relation, the memory upper limit for query processing, the number of distinct values in a column, and the number of aggregation attributes.

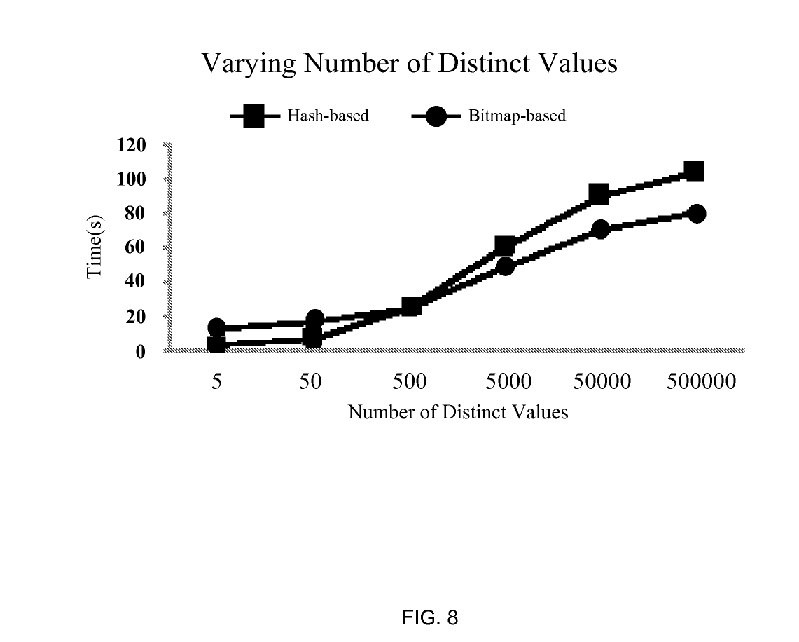

Referring to FIG. 8, therein is depicted a graph comparing bitmap-based and hash-based aggregation performance for different numbers of distinct values. FIG. 8 shows, inter alia, the impact of the number of distinct values on the performance of both methods. As shown in FIG. 8, when the number of distinct values is reasonable large, bitmap-based processes according to embodiments present better performance compared with the hash-based processes. Realistic data sets will likely have a large number of distinct values in the relation. For example, 1% of the total number of tuples will be 100,000 for a table with 10 million tuples. Accordingly, bitmap-based processes according to embodiments outperform conventional hash table processes for realistic data sets.

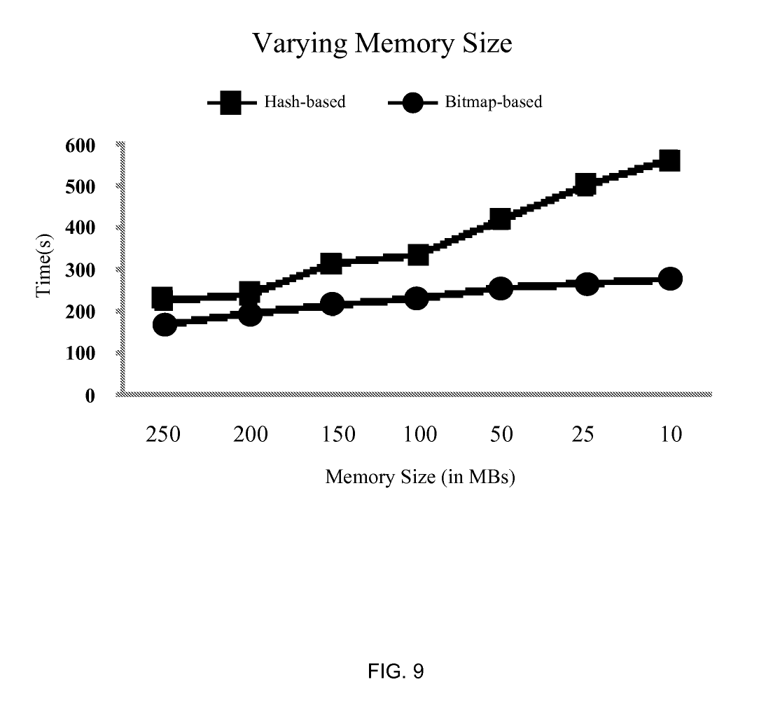

FIG. 9 provides a graph of bitmap-based and hash-based aggregation for different sizes of available memory. In the non-limiting example depicted in FIG. 9, a relation with 30 million tuples was used, the number of distinct values was 300,000 for every column, and the number of aggregation attributes was 2. The ratios of memory size divided by data size in FIG. 9 are 43.7%, 34.9%, 26.2%, 17.5%, 8.7%, 4.3%, and 1.7%, respectively. FIG. 9 demonstrates, among other things, that when the memory upper bound for query processing decreases, aggregation processes according to embodiments performs better compared with hash-based method in all test cases. Accordingly, aggregation processes according to embodiments are more memory-efficient and better able to handle large amounts of data using a relatively small amount of memory compared with conventional hash-based methods.

In addition, FIG. 9 demonstrates that performance gains are more significant when the size of memory decreases. According to embodiments, when memory size decreases, the relation is split into more partitions for processing. However, the partitions still contain relatively large numbers of distinct values (e.g. if split into 10 partitions, each partition still has 1 million tuples, which may contain many distinct values). For the processing of each partition, the bitmap-based method according to embodiments outperforms the hash-based method. In practice, memory size will not be specified to be very small (e.g., 100 kb). Therefore, the distinct values in each partition will still be relatively large.

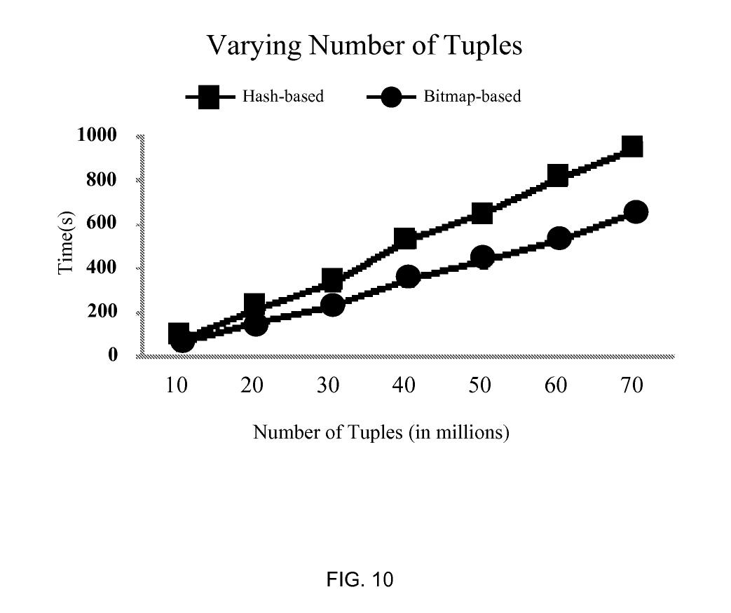

FIG. 10 provides a graph of bitmap-based and hash-based processes for varying numbers of tuples. In addition, FIG. 10 represents the scalability of both aggregation processes. When the number of tuples in the relation increases from 10 million to 70 million, the bitmap-based method demonstrated better scalability over increasing data size. This is consistent with the graph provided in FIG. 9, because when the number of tuples increases, the ratio of memory and data decreases. Accordingly, the performance differences in FIG. 10 between the bitmap-based and hash-based methods are similar to those depicted in FIG. 9 for similar reasons.

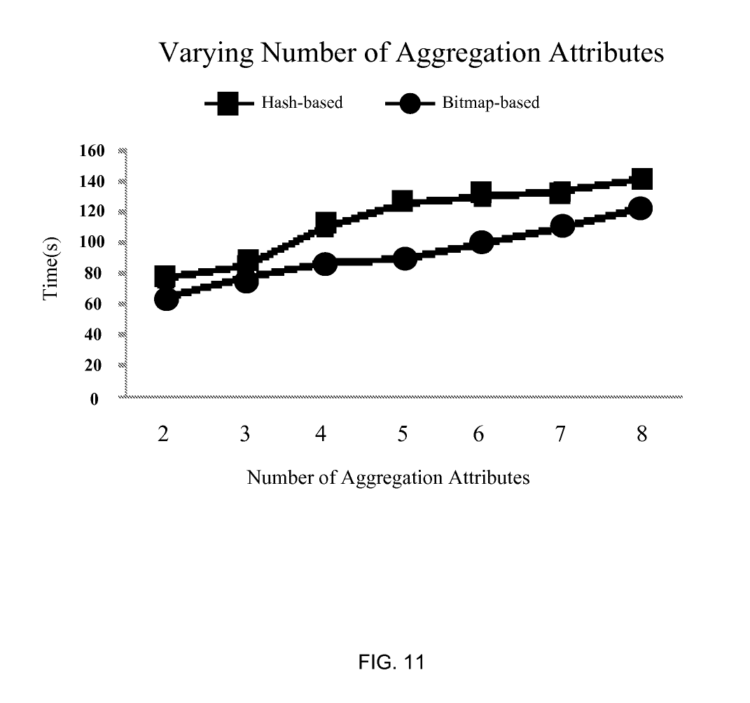

Referring to FIG. 11, therein is depicted a graph of bitmap-based and hash-based processes over varying numbers of aggregation attributes. The increase in processing time for both methods is similar because the increase of aggregation attributes resulted in the same amount of additional data for query processing. Nonetheless, the bitmap-based method demonstrated better performance than the hash-based method over the different number of aggregation attributes.

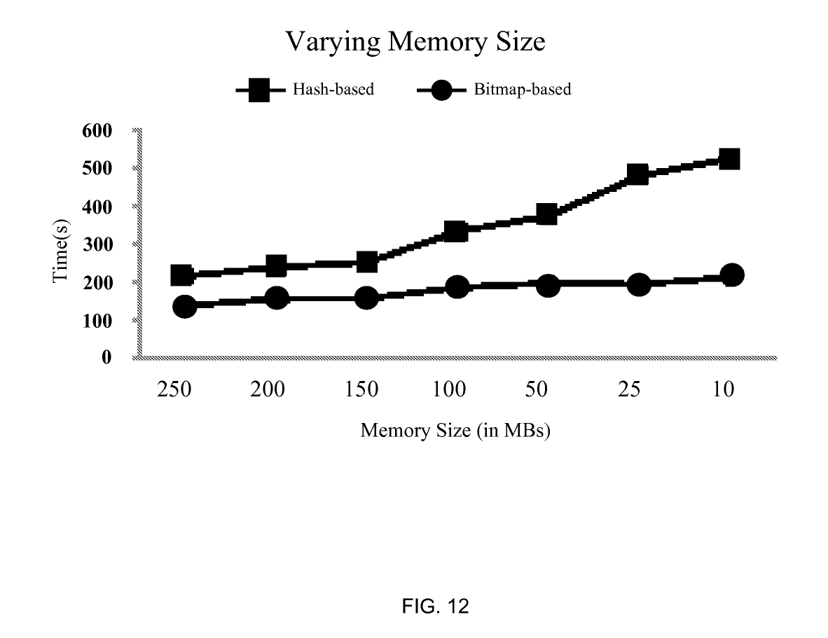

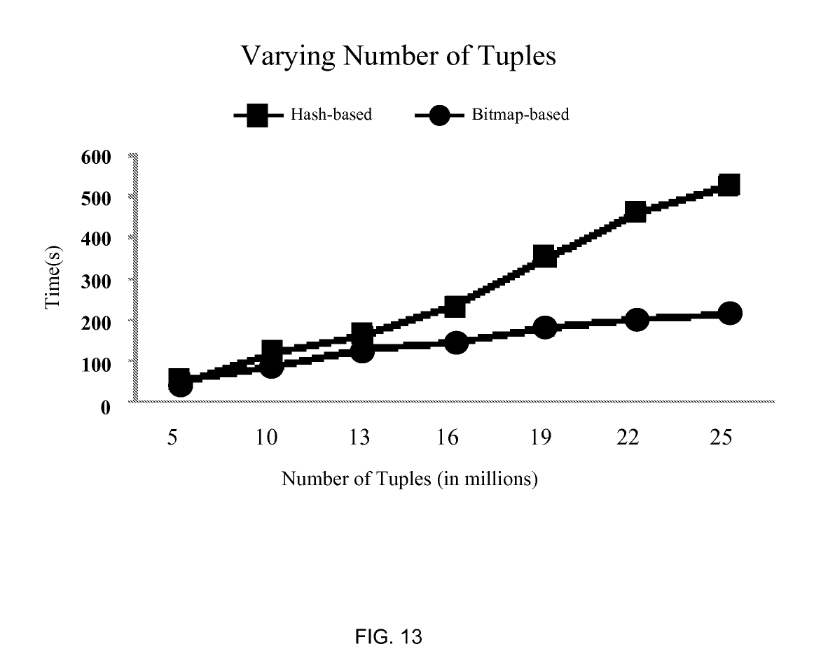

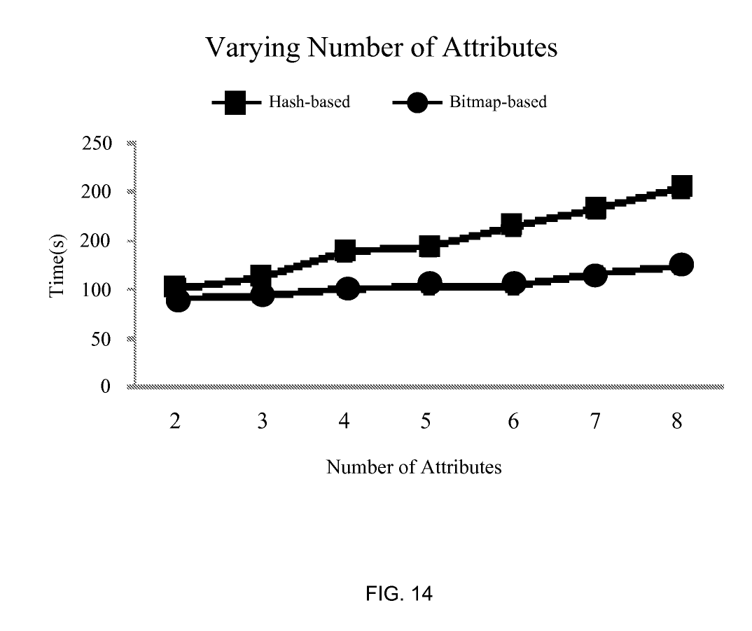

Further experiments were performed using realistic data containing one relation with nine attributes, wherein the number of distinct values was not controlled. Referring to FIG. 12, therein is provided a graph of bitmap-based and hash-based methods over the realistic data set for varying memory sizes. FIG. 13 depicts a graph of bitmap-based and hash-based processes over different numbers of tuples using the realistic data set. FIG. 14 provides a graph of bitmap-based and hash-based processes using the realistic data over varying numbers of attributes.

FIGS. 12-14 demonstrate, inter alia, that the bitmap-based method according to embodiments and the hash-based method displayed similar behaviors on both the realistic data set and the synthetic data set. In addition, FIGS. 12-14 show that aggregation processes according to embodiments provide superior performance on the realistic data set compared with hash-based aggregation processes. Furthermore, FIGS. 12-14 reinforce the memory efficiency of aggregation methods according to embodiments. For example, when the amount of available memory for query processing decreases, aggregation processes according to embodiments show a much slower increase in processing time compared to conventional methods.

The experimental results using the realistic data demonstrates that assumptions made during evaluation of the synthetic data set (i.e., Zipfian) matches characteristics of the realistic data. Accordingly, evaluation using a synthetic data set is representative of realistic data set. In addition, the bitmap-based and hash-based methods demonstrated similar behavior on both data sets, further indicating that bitmap-based methods according to embodiments provided better performance than aggregation methods according to present technology.

Embodiments provide an efficient and scalable aggregation process. Aggregation processes according to embodiments provide a performance advantage compared to aggregation processes according to current technology, especially when the number of aggregation attributes is relatively small. Embodiments provide for the use of several smaller hash tables instead of a large hash table for processing aggregation queries. The use of multiple smaller hash tables according to embodiments improves the performance and efficiency of aggregation queries. In addition, embodiments provide for aggregation methods that leverage the bitmap index and the data array such that aggregation computations are partitioned into a set of smaller problems, which are better able to achieve increased performance, efficiency, and scalability. Embodiments described herein focus on column oriented databases as a prominent example, but are not so limited, as embodiments may operate on any type of database capable of taking advantage of aggregation processes as described in this disclosure.

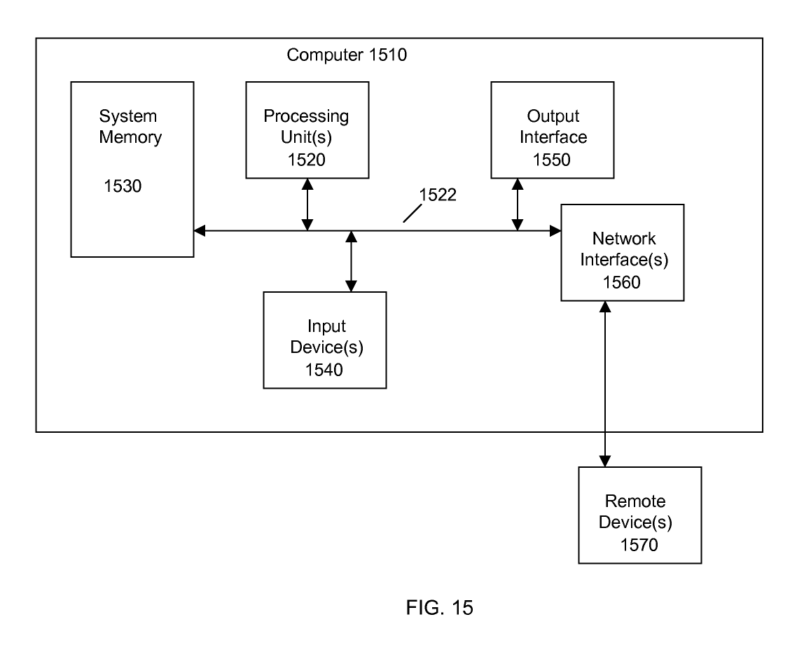

Referring to FIG. 15, it will be readily understood that embodiments may be implemented using any of a wide variety of devices or combinations of devices. An example device that may be used in implementing one or more embodiments includes a computing device in the form of a computer 1510. In this regard, the computer 1510 may execute program instructions; map the data utilizing a bitmap index; receive at least one database query; process the at least one database query by determining positions of query attributes in the at least one bitmap index and locating values corresponding to the positions in the at least one data array; and other functionality of the embodiments, as described herein.

Components of computer 1510 may include, but are not limited to, processing units 1520, a system memory 1530, and a system bus 1522 that couples various system components including the system memory 1530 to the processing unit 1520. Computer 1510 may include or have access to a variety of computer readable media. The system memory 1530 may include computer readable storage media in the form of volatile and/or nonvolatile memory such as read only memory (ROM) and/or random access memory (RAM). By way of example, and not limitation, system memory 1530 may also include an operating system, application programs, other program modules, and program data.

A user can interface with (for example, enter commands and information) the computer 1510 through input devices 1540. A monitor or other type of device can also be connected to the system bus 1522 via an interface, such as an output interface 1550. In addition to a monitor, computers may also include other peripheral output devices. The computer 1510 may operate in a networked or distributed environment using logical connections to one or more other remote computers or databases, such as a column oriented database. The logical connections may include a network, such as a local area network (LAN) or a wide area network (WAN), but may also include other networks/buses.

It should be noted as well that certain embodiments may be implemented as a system, method or computer program product. Accordingly, aspects of the invention may take the form of an entirely hardware embodiment, an entirely software embodiment (including firmware, resident software, micro-code, et cetera) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied therewith.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, et cetera, or any suitable combination of the foregoing.

Computer program code for carrying out operations for aspects of the invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatuses (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

1. A system comprising:
at least one processor;
a system memory operatively coupled to the at least one processor;
at least one database module communicatively coupled to the system memory and at least one database;
at least one data array configured to store data in the database; and
at least one bitmap index configured to map the data;
wherein the at least one database module is adapted to:
receive at least one database query for the at least one database; and
process the at least one database query by determining for the at least one database query positions of query attributes in the at least one bitmap index and locating values corresponding to the positions in the at least one data array.

2. The system according to claim 1, wherein the at least one database is a column oriented database.

3. The system according to claim 1, wherein the at least one database query comprises at least one aggregation function.

4. The system according to claim 1, wherein the at least one bitmap index and the at least one data array are divided into smaller partitions.

5. The system according to claim 4, wherein dividing the at least one bitmap index and the at least one data array into smaller partitions comprises:
calculating a total memory required value by summing a size of data array value, a size of bitmap index value, and a size of hash table value; and
dividing the total memory required value by a memory upper bound value.

6. The system according to claim 1, wherein the at least one bitmap index is compressed.

7. The system according to claim 6, wherein the at least one bitmap index is compressed using a Word-Aligned Hybrid compression method.

8. The system according to claim 2, further comprising:
a plurality of columns, the plurality of columns comprising:
a first column selected from the plurality of columns, the first column comprising at least one first column attribute stored in a first data array; and
at least one secondary column comprising at least one secondary column attribute stored in at least one secondary data array;
wherein the at least one bitmap index maps data using at least one bitmap vector;
wherein processing database queries comprises:
selecting a bitmap vector for a first column attribute; and
for each bit in the bitmap vector:
locating a vector position of the bit in the selected bitmap vector;
locating a secondary column attribute in the secondary data array at a data array position corresponding to the vector position; and
updating a count of first column attribute and secondary column attribute occurrences in a hash table.

9. The system according to claim 8, wherein the first column is selected based on which column has a bitmap index with a smallest bitmap index size.

10. The system according to claim 8, wherein the first column is selected based on which column has a data array with a largest data array size.

11-19. (canceled)

20. A computer program product comprising:
a computer readable storage medium having computer readable program code embodied therewith, the computer readable program code comprising:
computer readable program code configured to access at least one database storing data in at least one data array;
computer readable program code configured to map the data utilizing a bitmap index;
computer readable program code configured to receive at least one database query for the at lest one database; and
computer readable program code configured to process the at least one database query by determining positions of query attributes in the at least one bitmap index and locating values corresponding to the positions in the at least one data array.
